(19) United States
(12) Patent Application Publication
(10) Pub. No.: US 2014/0100837 A1
(43) Pub. Date: Apr. 10, 2014

(54) INTEGRATION VERIFICATION SYSTEM

(71) Applicants: Stefan Heinen, Dueren (DE); Juergen Brock, Ottobrunn (DE); Sindhura Radhakrishnan, Bangalore (IN); Rajshekhar N. Paragond, Bangalore (IN); Shrinivas Rao K. Gowde, Bangalore (IN); Ragu T. Ramachandrarao, Bangalore (IN); Jonas Hoelscher, Duesseldorf (DE); Goran Magerl, Duesseldorf (DE)

(72) Inventors: Stefan Heinen, Dueren (DE); Juergen Brock, Ottobrunn (DE); Sindhura Radhakrishnan, Bangalore (IN); Rajshekhar N. Paragond, Bangalore (IN); Shrinivas Rao K. Gowde, Bangalore (IN); Ragu T. Ramachandrarao, Bangalore (IN); Jonas Hoelscher, Duesseldorf (DE); Goran Magerl, Duesseldorf (DE)

(21) Appl. No.: 13/646,789

(22) Filed: Oct. 8, 2012

(51) Int. Cl. G06F 17/50

(52) U.S. Cl. 703/14

(57) ABSTRACT

A verification system for an integrated device includes a plurality of detailed subsystem virtual prototypes, a plurality of fast subsystem virtual prototypes, and a test controller. The plurality of detailed system virtual prototypes include simulation information for core functionality of subsystems of the device. The plurality of fast system level prototypes include simulation information to facilitate overall functionality of the combined subsystems of the device.

### BACKGROUND OF THE INVENTION

At one time, consumer devices had a relatively focused purpose and functionality. A camera operated as a camera, a phone operated as a phone, a network device operated as a network device, and an audio device operated as an audio device. However, recent consumer devices tend to include a relatively large variety of features and functions. A camera often includes audio features, video camera features, and networking features. A phone can include video playback features, camera features, calling features, and the like.

Due to rapidly evolving technology, short time to market is an issue. Designing these recent consumer devices with the stringent time and budgetary constraints can be a challenge.

### BRIEF DESCRIPTION OF THE DRAWINGS

FIG. 1 is a diagram illustrating a system on chip having subsystems and modules.

FIG. 2 is a diagram showing typical layers of abstraction for a subsystem.

FIG. 3 is a diagram illustrating varied detail subsystem models for a single subsystem 300 of a system on chip design.

FIG. 4 is a diagram illustrating detailed testing models for subsystems of a system on chip design.

FIG. 5 is a diagram illustrating fast testing models for subsystems of a system on chip design.

FIG. 6 is a diagram illustrating a detailed setup or stage of verification for a system on chip design of a subsystem.

FIG. 7 is a diagram illustrating a fast stage or setup of verification for a system on chip design of a system.

FIG. 8 is a flow diagram illustrating a method of testing a virtual platform.

### DETAILED DESCRIPTION OF THE INVENTION

The present invention will now be described with reference to the attached drawing figures, wherein like reference numerals are used to refer to like elements throughout, and wherein the illustrated structures and devices are not necessarily drawn to scale.

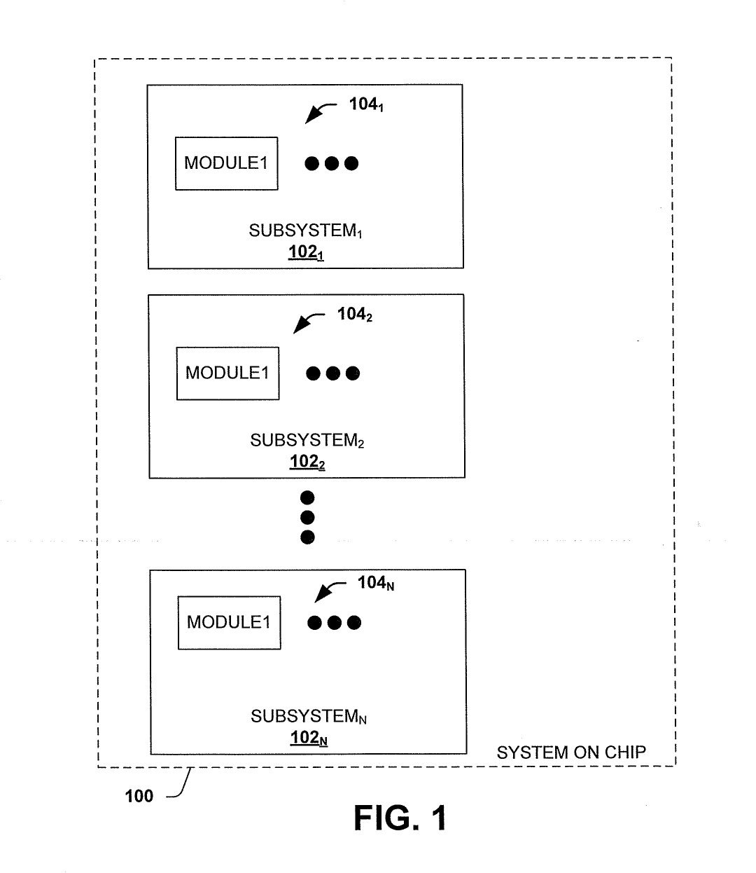

FIG. 1 is a diagram illustrating a system on chip 100 having subsystems and modules. The system on chip (SOC) 100 integrates a number of subsystems in order to provide functionality for a variety of systems and features. The system on chip 100 can include, for example, gaming, camera, audio playback, video playback storage, and the like features.

The chip 100 includes a plurality of subsystems 102. The subsystems 102 include features, which are then integrated into the system on chip 100. Some examples of subsystems include, storage subsystems, Bluetooth connectivity, UMTS, security, ultra wide bandwidth (UWB), 3 dimensional graphics, VGA, and the like.

The subsystems 102 can include one or more modules 104 that perform specific functions or features. The modules 104 can be specific to a single subsystem or can be utilized by a plurality of the subsystems 102. In one example, similar modules, but not identical ones, are used per subsystem. The modules can include, for example, a power amplifier, signal module, signal bus, and the like.

Designing a system on chip device, such as the system on chip 100, can be challenging. The various subsystems 102 of the chip 100 are designed prior to completion of the hardware design. The chip 100 can be designed with one or more general purpose processor cores with application specific hardware components.

One technique to develop and design similar system on chips is to utilize full system on chip virtual prototyping (VP). This provides a detailed computer based model and/or simulation environment, which simulates an entire system on chip solution. This technique does permit SOC development in parallel with development of hardware. However, simulation times for such complex simulations can be excessive. A single SOC can require hundreds of hours of simulation and delay completion and/or verification of the SOC design. Furthermore, any failures require design changes and re-simulation (also referred to as turns), which tend to multiply the amount of time needed.

However, the system on chip 100 is simulated and verified using a layered verification approach. Subsystem models are generated for the subsystems with varied levels of detail. For example, a detailed model of each subsystem permits verification of the subsystems at a high level of detail, but without testing all the other subsystems and modules at the same time, which would not be feasible in one system. Then, faster (less detailed) subsystem models are used to test the overall system on chip 100 and integration of the subsystems 102.

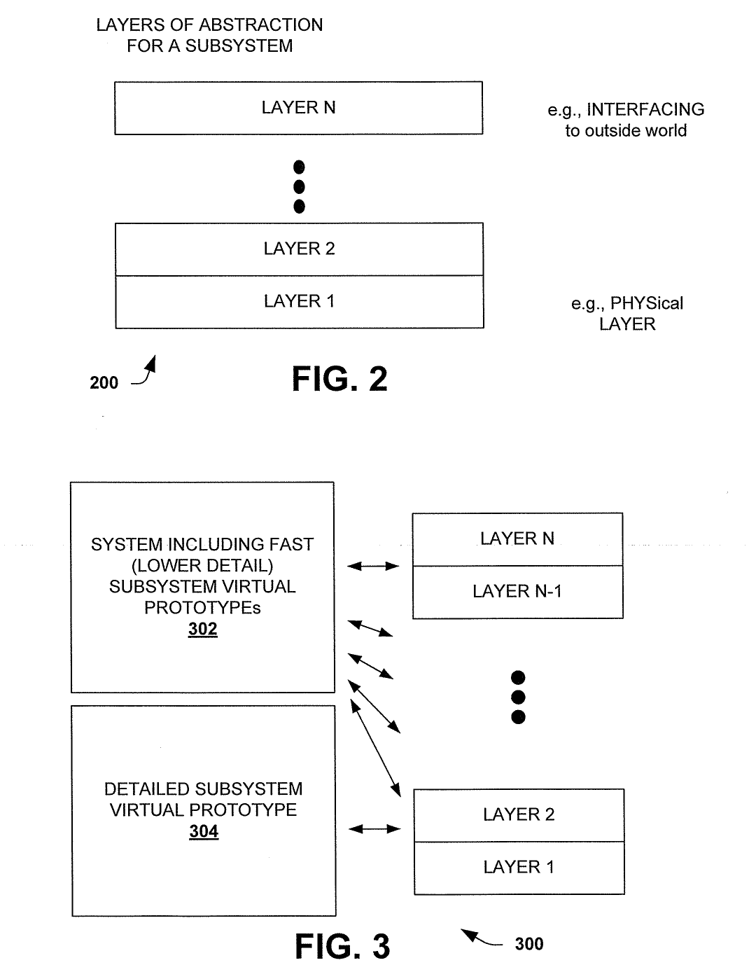

FIG. 2 is a diagram showing typical layers 200 of abstraction for a subsystem. The subsystem includes a number of layers that facilitate design and implementation. In this example, the layers 200 relate to communications or networking.

The layers 200 can include physical layers, data link layers, network layers, transport layers, session layers, application layers, and the like. Generally, each layer serves a layer above and is served by a layer below.

Typically, the lowest layer is a physical layer and it defines electrical and physical specifications for devices. In particular, it defines the relationship between a device and a transmission medium, such as a copper or fiber optical cable. This includes the layout of pins, voltages, line impedance, cable specifications, signal timing, hubs, repeaters, network adapters, host bus adapters (HBA used in storage area networks) and more. The physical layer performs functions including establishment of connections, sharing in resources, modulation or conversion of digital data, and the like.

An example of a higher layer is a transport layer. This layer facilitates transfer of data between end users and provides reliable data transfer services to the upper layers. The transport layer controls the reliability of a given link through flow control, segmentation/desegmentation, and error control. The transport layer also provides the acknowledgement of the successful data transmission and sends the next data if no errors occurred.

FIG. 3 is a diagram illustrating varied detail subsystem models 300 for a system on chip design. The subsystem models 300 correspond to one or more subsystems for the SOC.

The models 300 include an overall system model 302 and a detailed subsystem virtual prototype (VP) model. The overall system model 302 includes one or more lower detail subsystem virtual prototypes. The lower detail subsystem virtual prototypes have a lower level of detail sufficient to permit testing of the overall system model 302. The overall system model 302 typically tests higher layer functionality, such as networking, interfacing, and the like. The overall system model and lower detail VPs correspond to higher layers, as shown in FIG. 3, but also can model some details of other layers.

The detailed subsystem virtual prototype (VP) 304 is used to model the lower level behavior of a single subsystem. For example, the detailed subsystem VP 304 can correspond to a physical layer for the subsystem. Then, the VP 304 models behavior of the physical layer for the subsystem. By focusing on the functionality of the lower layer or layers, the detailed VP 304 can be simulated in a relatively short time.

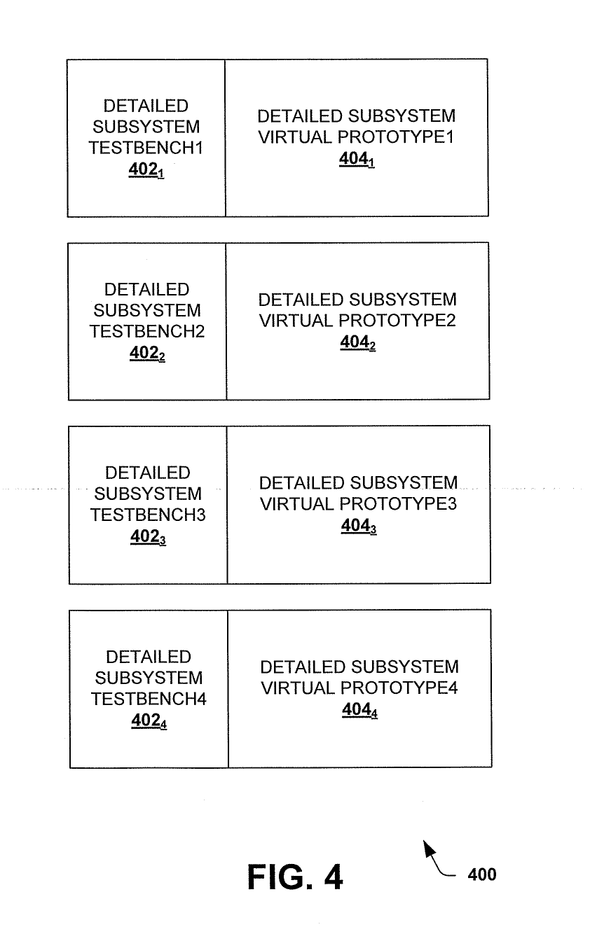

FIG. 4 is a diagram illustrating detailed testing models for subsystems of a system on chip design 400. The testing models include a relatively high level of detail and can correspond to lower layers, such as physical layers.

The design 400 is simulated at a high level and includes detailed subsystem virtual prototypes 404 and corresponding detailed subsystem testbenches 402. Generally, a testbench is a virtual environment used to test or verify the correctness or soundness of a design. The testbenches 402 include a variety of components including, but not limited to, an input component, a task component, a check component, and an output component. The input component permits specifications and criteria to be input. Additionally, the input component facilitates selection of information to be provided by the test bench. The task component includes tasks or processes to perform on a model. The check component verifies or determines whether outputs or tasks are performed in compliance with the specifications and/or performance criteria. The output component provides deliverables, such as output signals, performance information, and the like.

The detailed subsystem virtual prototypes (VPs) 404 are detailed models of individual subsystems for the system on chip design 400. The detailed VPs 404 are specific to a corresponding subsystem and include lower layers of abstraction. The detailed VPs 404 can omit higher level features and/or functionality to facilitate simulation and verification.

The detailed subsystem testbenches 402 are specific to the detailed VPs 404. Thus, each of the testbenches 402 has components configured to perform subsystem specific verification. Thus, input components, output components, check components, and task components are specific to the corresponding detailed VP.

A testing tool (not shown) can be utilized with the testbenches 402 and the detailed subsystem VPs to perform lower level testing of the subsystems of the SOC design. In one example, the testing tool performs verification on each subsystem by running tests with one of the detailed subsystem virtual prototypes and the corresponding testbench. Thus, each subsystem is tested using the detailed models.

The models 402 and 404 provide a setup that facilitates testing of lower layer functionality of the system on chip design 400. Each of the subsystem VPs 404 only contains a portion of the elements of the overall design 400. Thus, simulation speeds for the individual VPs is acceptable, such as less than 10 hours for one test case.

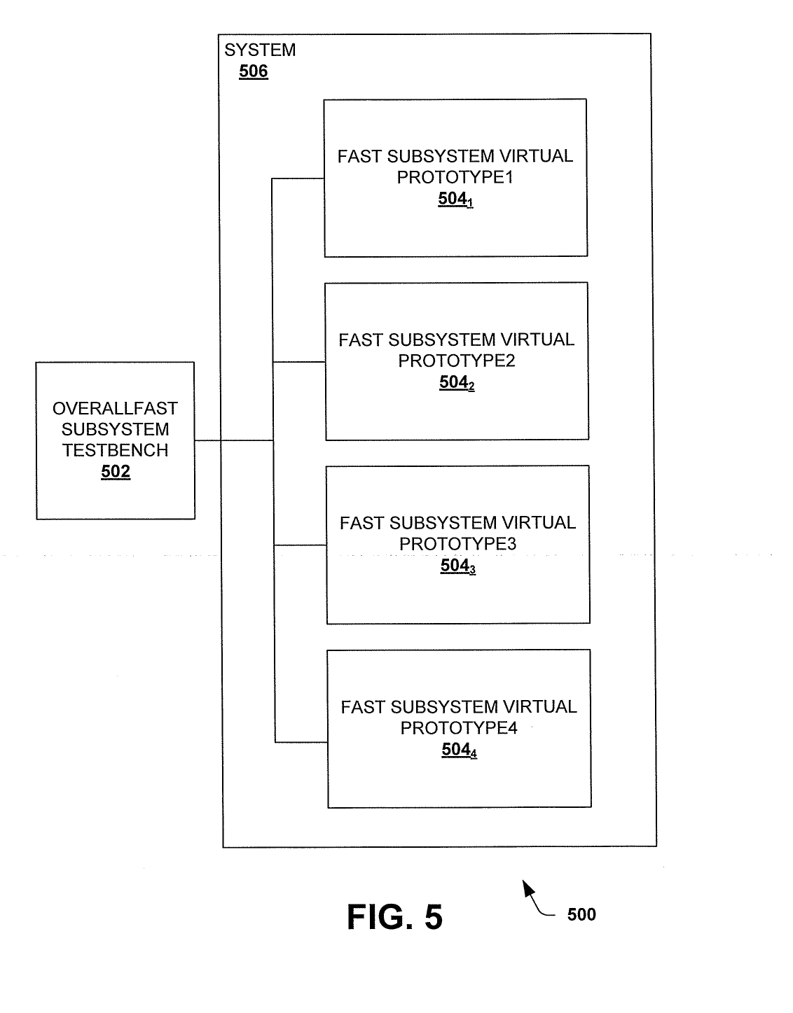

FIG. 5 is a diagram illustrating fast testing models for subsystems of a system on chip design 500. The testing models include a relatively low level of detail and typically correspond to high layers of abstraction, such as a transport layer. The low level of detail permits faster simulation of multiple models simultaneously and facilitates testing of the overall system on chip design 500. The fast models are typically utilized after simulation and verification using the detailed models.

For this phase of testing, the design 500 is modeled using an overall fast subsystem testbench 502 and a plurality of fast subsystem virtual prototypes 504. The plurality of fast subsystem virtual prototypes 504 are included in an overall system virtual prototype 506. The testbench 502 is a virtual environment used to test or verify the correctness or soundness of the design 500.

The testbench 502 includes a variety of components such as an input component, a task component, a check component, and an output component. The input component permits specifications and criteria to be input. Additionally, the input component facilitates selection of information to be provided by the test bench. The task component includes tasks or processes to perform on a model. The check component verifies or determines whether outputs or tasks are performed in compliance with the specifications and/or performance criteria. The output component provides deliverables, such as output signals, performance information, and the like.

The overall testbench 502 provides an overall environment for the design and includes interfacing between subsystems and communications external to the overall design 500. Here, the testbench 502 interacts with the overall system virtual prototype 506 and at least a portion of the plurality of virtual prototypes. In one example, the testbench 502 interacts with a combination of the virtual prototypes 504.

The use of the detailed subsystem virtual prototypes 504 provides real time improvement factors of about 1:1000 when used in a suitable test environment compared with conventional full system and full functionality simulations.

The fast subsystem virtual prototypes 504 have a reduced or abstracted level of detail. The VPs 504 omit, for example, some of the core functionality of the detailed models described in FIG. 4. In one example, the reduced level of modeling is suitable for the subsystem VPs 504 because the testbench(es) 502 focuses on higher level functionality, such as interfacing between the subsystems. The detailed, lower level functionality has already been tested by the setup described in FIG. 4.

The models 502 and 504 provide an overall test setup that facilitates testing of the overall design 500 while doing so in a reasonable amount of time. The reduced level of detail in the models 502 and 504 also reduces the simulation time.

The setups disclosed for FIGS. 4 and 5 permits simulation of a system on chip design, such as a complete mobile platform. This is feasible due to the varied levels of detail utilized for the first or detailed setup and the second or fast setup:

In one example, the virtual prototypes 404 and 504 are configured for each subsystem. Detailed or fast subsystem prototypes are then selected according to a mode of operation or current test setup/phase.

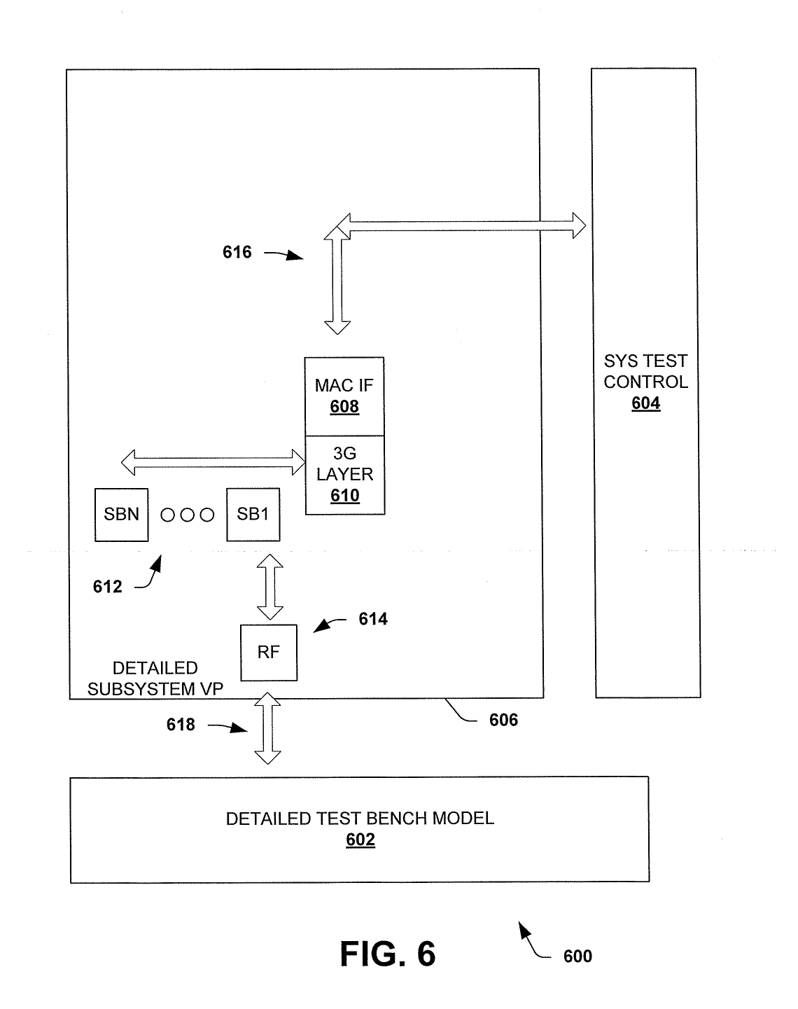

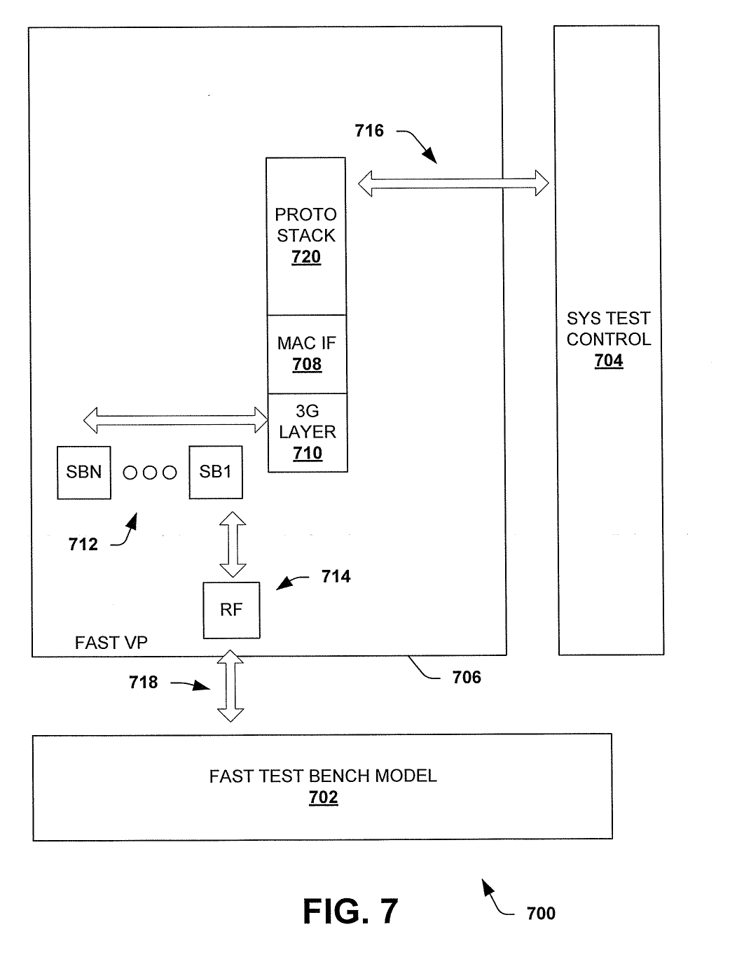

FIGS. 6 and 7 illustrate two stages of verification or testing of a system on chip design. The two stages, also referred to as phases or setups provide incremental and layered testing. The first or detailed stage uses detailed subsystem models and generally tests the core functionality of subsystems of the system on chip design. The second or fast stage uses lower detail subsystem models to test higher level functionality of the subsystems, including interconnectivity. These FIGS. 6 and 7 are provided with additional details to facilitate understanding. However, it is appreciated that suitable variations are permitted.

FIG. 6 is a diagram illustrating a detailed setup or stage 600 of verification for a system on chip design of a subsystem. The detailed setup 600 uses detailed models for subsystems and testbenches to test features of the subsystems, such as the core functionality of the subsystems. The stage 600 depicts a 3G subsystem virtual prototype and its detailed testbench.

The setup 600 includes a detailed testbench 602, a system test control 604, and a subsystem virtual prototype 606. The detailed testbench 602 is one of a number of detailed testbenchs that simulate an operating environment for the subsystem VP 606. The detailed testbench 602 includes components configured to perform subsystem specific verification. In one example, the testbench 602 includes an input component, an output component, a check component, and a task component. In one example, the testbench 602 includes or represents a base station of a cellular phone network.

The system test control 604 performs detailed testing of the subsystem VP 606. Typically, the system test control 604 performs testing of all subsystem VPs for a system on chip design separately. It is appreciated that a number of other subsystem VPs are present and testable by the system test control 604.

The subsystem VP 606 includes a variety of modules including an RF component 614, one or more other modules 612, a MAC interface model 608, a 3G layer microcontroller model 610, a control bus 616, and an RF bus or connection 618. The detailed RF component 614 is coupled to the testbench model 602 via the RF connection 618. The RF component 614 communicates with the current testbench model. It is appreciated that the RF component 614 is an example of a physical communication medium interface and that other interface components can be employed in addition to or instead of the RF component 614.

The other detailed modules 612 are models of various modules of the system on chip design. The other modules 612 can include transmit VPs, receive VPs, a RAKE VP, and the like. It is appreciated that the modules 612 and 614 are detailed models.

The test control 604 selects and performs testing of the subsystem VP 606 using the testbench 602. The testing can include a variety of tasks including, but not limited to, cell search, network registration, call setup, data transmission, call release, and the like. The test control 604 is coupled to the VP 606 and the detailed testbench model 602. The test control 604 utilizes the control bus 616 to provide commands or signals to the MAC IF 608. The RF subsystem 618 provides the outputs and information that can be analyzed to determine or verify proper operation of the current subsystem.

The test control 604 performs lower level/layer testing of the subsystem using, for example, complex baseband (I/Q) symbols. The test control 604 can also test the other subsystem VPs of the design.

FIG. 7 is a diagram illustrating a fast stage or setup 700 of verification for a system on chip design of a system. The fast setup 700 uses lower detail models, which are referred to as faster models because they require less simulation time and resources than higher or full detail models. The fast stage 700 utilizes the fast models for the subsystem and testbench to test higher level features of the subsystems and the design, such as interfacing between subsystems. The setup 700 uses a base station model as the testbench in order to test a 3G subsystem.

The fast stage 700 includes a single fast testbench model 702, a system test control 704, and a fast subsystem virtual prototype (VP) 706. The fast testbench model 702 simulates an operating environment for an overall system on chip design. The fast testbench model 702 includes components configured to perform or simulate higher level functionality of the design, such as interfacing between subsystems.

The system test control 704 is similar to the test control 604 of FIG. 6, except that the system test control 704 performs verification testing on the overall system on chip design. Thus, many or all fast subsystem VPs are tested concurrently or as a combined system.

The fast subsystem VP 706 includes a number of fast (lower detail) modules, such as a fast RF component 714, one or more other components 712, a MAC interface model 708, a 3G layer microcontroller model 710, a control bus 716, an RF bus 718, and a protocol stack 720. The fast RF module 714 is coupled to the fast testbench model 702 via the RF bus 718. The fast RF module 714 communicates with the fast testbench model 702.

The other modules 712 are models of the various modules of the system on chip design. The other modules can include transmit VPs, receive VPs, a RAKE VP, and the like. The test control 704 verifies testing by simulating operation of substantially all the subsystem VPs 712 concurrently.

The test control 704 interacts with the protocol stack 720 via the control bus 716 to perform various tasks for testing. The tasks can include, for example, scrambling codes, channelization codes, RF power, and the like. The test control 704 utilizes the control bus 716 to provide commands or signals to the protocol stack 720. In turn, the stack 720 communicates with the other layers 708 and 710 and the modules 712 and 714. The test control 704 generates outputs or test results that can then be utilized to verify proper operation of the system on chip or used to modify the design.

The test control 704 interacts with other subsystem VPs concurrently with the fast subsystem VP 706. As a result, a system on chip design or platform can be tested.

A typical simulation for a 3G device includes cell search, network registration, call setup, data transmission, call release, and the like. The duration is typically in the range of 20-100 seconds for each task. Testing all the tasks can take up to 24 hours. Thus, an interactive simulation could be time prohibitive.

Using the setups described in FIGS. 6 and 7 reduces simulation time by a factor of 10 and makes simulation based verification testing feasible.

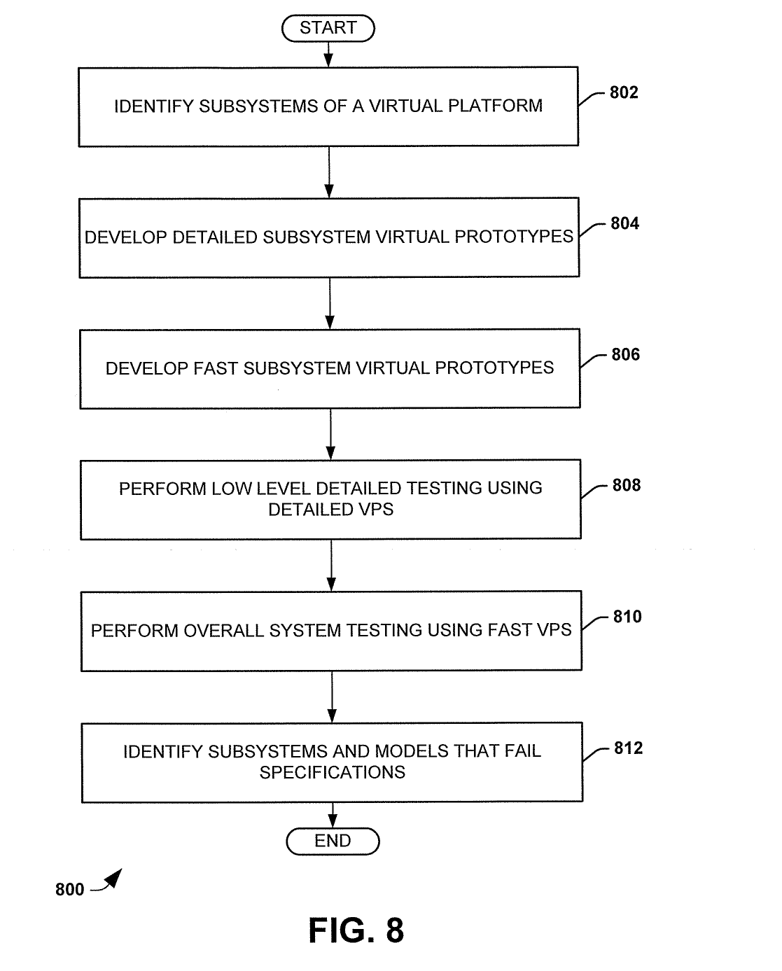

FIG. 8 is a flow diagram illustrating a method 800 of testing a virtual platform, such as a communications platform. The method 800 uses a cascaded approach and models having varied levels of detail.

The method begins at block 802, wherein a plurality of subsystems are identified for the platform. The virtual platform includes simulation models of a system on chip and its operating environment. The plurality of subsystems include various applications, such as communications, networking, video playback, and the like.

Detailed subsystem virtual prototypes are developed for each of the identified subsystems at block 804. The detailed subsystem virtual prototypes include core functionality of the identified subsystems. For example, the core functionality can include generation and processing of baseband symbols.

In addition to the detailed subsystem virtual prototypes, detailed testbench models are developed for each of the subsystems. The testbench models model or simulate environments particular to corresponding subsystems.

Fast subsystem virtual prototypes are developed for each of the identified subsystems at block 806. The fast subsystem virtual prototypes typically omit core functionality of the identified subsystems. Instead, the fast subsystem virtual prototypes include subsystem interfacing and communication and overall system functionality.

In addition to the fast subsystem virtual prototype, an overall fast testbench is developed to simulate an overall environment for the collective subsystems. The overall testbench applies to all the fast subsystem virtual prototypes.

Low level detailed testing is performed at block 808. The low level detailed testing is performed separately for each subsystem. The low level detailed testing tests the core functionality of each subsystem. For example, the low level detailed testing can include testing of physical layers of the subsystems.

Overall system testing is performed at block 810 using the fast subsystem virtual prototypes. The overall testing includes system wide testing using all or some of the fast subsystem virtual prototypes. The overall testing includes, for example, testing interfacing between subsystems and the like.

Subsystems, including modules, of the system on chip design are identified that fail to comply with specifications or standards at block 812. For example, a communication subsystem can be identified that fails to meet a required communication standard. The failed items can then be re-designed and the design can be re-tested as described above.

While the methods provided herein are illustrated and described below as a series of acts or events, the present disclosure is not limited by the illustrated ordering of such acts or events. For example, some acts may occur in different orders and/or concurrently with other acts or events apart from those illustrated and/or described herein. In addition, not all illustrated acts are required and the waveform shapes are merely illustrative and other waveforms may vary significantly from those illustrated. Further, one or more of the acts depicted herein may be carried out in one or more separate acts or phases.

Furthermore, the claimed subject matter may be implemented as a method, apparatus, or article of manufacture using standard programming and/or engineering techniques to produce software, firmware, hardware, or any combination thereof to control a computer to implement the disclosed subject matter (e.g., the systems shown in FIG. 2, 3, etc., are non-limiting examples of circuits that may be used to implement method 800 and/or variations thereof). The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

A verification system for an integrated device includes a plurality of detailed subsystem virtual prototypes, a plurality of fast subsystem virtual prototypes, and a test controller. The plurality of detailed system virtual prototypes include simulation information for core functionality of subsystems of the device. The plurality of fast system level prototypes include simulation information for non-core functionality of the subsystems of the device.

A verification system includes a first subsystem of a system on chip design, a second subsystem of the system on chip design, a first detailed subsystem virtual prototype for the first subsystem, a second detailed subsystem virtual prototype for the second subsystem, a first fast subsystem virtual prototype for the first subsystem, a second fast subsystem virtual prototype for the second subsystem and testbenches coupled to the first detailed subsystem virtual prototype, the second detailed subsystem virtual prototype, the first fast subsystem virtual prototype, and the second fast subsystem virtual prototype.

A method of testing a system on chip or platform is disclosed. A plurality of subsystems are identified for the platform. Detailed subsystem virtual prototypes are developed for each of the plurality of subsystems. Fast subsystem virtual prototypes are developed for each of the plurality of subsystems. The fast subsystem virtual prototypes have a lower level of detail than the detailed subsystem virtual prototypes. Low level testing is performed of the detailed subsystem virtual prototypes. Overall system testing is performed using the fast subsystem virtual prototypes.

Although the invention has been illustrated and described with respect to one or more implementations, alterations and/or modifications may be made to the illustrated examples without departing from the spirit and scope of the appended claims. For example, although the transmission circuit described herein has been illustrated as a transmitter circuit, one of ordinary skill in the art will appreciate that the invention provided herein may be applied to transceiver circuits as well. Furthermore, in particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A verification system for an integrated device comprising:
a plurality of detailed subsystem virtual prototypes including core functionality simulation information;
a fast system virtual prototype having a plurality of fast subsystem virtual prototypes including overall integration functionality simulation information;
a test controller configured to test lower layer functionality of the device using the detailed subsystem virtual prototypes and to test higher layer functionality of the device using the fast system virtual prototype and the fast subsystem virtual prototypes.

2. The system of claim 1, wherein the detailed subsystem virtual prototypes and the fast subsystem virtual prototypes correspond to subsystems of the integrated device.

3. The system of claim 1, wherein the detailed subsystem virtual prototypes include a plurality of detailed module models.

4. The system of claim 1, wherein the detailed subsystem virtual prototypes include modeling of baseband layer receiver/transmitter hardware.

5. The system of claim 1, wherein the detailed subsystem virtual prototypes include modeling of complex baseband symbols (I/Q).

6. The system of claim 1, wherein the test controller is configured to perform testing of the detailed system for a single test task spanning less than about 40 seconds simulated time and which corresponds to a simulation duration of about 20 hours, whereas in fast mode the simulation duration is reduced to less than 2 hours.

7. The system of claim 1, wherein the test controller is configured to perform low level tasks to test the lower layer functionality.

8. The system of claim 7, wherein the low level tasks include scrambling codes, channelization codes, and RF power tasks, cell search (temporary remark: cell of the cellular network).

9. The system of claim 1, wherein the test controller is configured to perform high level tasks to test the higher layer functionality.

10. The system of claim 9, wherein the high level tasks include, network registration, call setup, data transmission and call release tasks.

11. The system of claim 1, further comprising a plurality of detailed test benches coupled to the test controller and utilized to test the lower layer functionality.

12. The system of claim 11, further comprising one or more additional test controllers coupled to at least a portion of the plurality of detailed test benches.

13. The system of claim 1, further comprising a fast test bench coupled to the test controller and utilized to test the higher layer functionality.

14. The system of claim 1, wherein the test controller is further configured to test at least some lower layer functionality using the fast system virtual prototype.

15. A verification system comprising:
a first subsystem of a system on chip design;
a second subsystem of the system on chip design to the first subsystem;
a first detailed subsystem virtual prototype for the first subsystem;
a second detailed subsystem virtual prototype for the second subsystem;
a first fast subsystem virtual prototype for the first subsystem;
a second fast subsystem virtual prototype for the second subsystem; and
testbenches coupled to the first detailed subsystem virtual prototype, the second detailed subsystem virtual prototype, the first fast subsystem virtual prototype, and the second fast subsystem virtual prototype.

16. The system of claim 15, wherein the first subsystem is of a group of subsystems comprising 3G, 2G, and LTE subsystems.

17. The system of claim 15, further comprising a third subsystem and a fourth subsystem coupled to the first and second subsystems.

18. The system of claim 13, further comprising a test control configured to perform detailed mode testing and fast mode testing.

19. The system of claim 18, wherein the detailed mode testing include cores functionality testing.

20. A method of testing a virtual platform, the method comprising:
identifying a plurality of subsystems for the platform;
developing detailed subsystem virtual prototypes for each of the plurality of subsystems;
developing fast subsystem virtual prototypes for each of the plurality of subsystems, wherein the fast subsystem virtual prototypes have a lower level of detail than the detailed subsystem virtual prototypes;
performing low level detailed testing of the detailed subsystem virtual prototypes; and
performing overall system testing using the fast subsystem virtual prototypes.

21. The method of claim 18, further comprising developing detailed test bench models for each of the plurality of subsystems.

22. The method of claim 18, wherein performing overall system testing includes testing a system virtual prototype of the fast subsystem virtual prototypes.
